(19) United States
(12) Patent Application Publication
(10) Pub. No.: US 2013/0098479 A1
(43) Pub. Date: Apr. 25, 2013

(54) Gas Extractor for Exhaust Gas Monitoring

(71) Applicant: SAFETY POWER INC., Mississauga (CA)

(72) Inventors: Robert M. Stelzer, Richmond Hill (CA); Karol Matacz, Mississauga (CA); Steven Fox, Mississauga (CA)

(73) Assignee: SAFETY POWER INC., Mississauga (CA)

(21) Appl. No.: 13/657,571

(22) Filed: Oct. 22, 2012

Related U.S. Application Data
(60) Provisional application No. 61/549,971, filed on Oct. 21, 2011.

(51) Int. Cl. F17D 1/00; G01M 15/10

(52) U.S. Cl. 137/560; 73/114.71

(57) ABSTRACT

An apparatus of a gas extractor for exhaust gas monitoring includes an extractor tube, an intake opening, a vent opening, and a plurality of sensors. The extractor tube is connected to an exhaust duct, where the exhaust duct provides an emitting gas flow. The plurality of sensors is attached to the extractor tube. A representative sample of the emitting gas flow travels through the intake opening into the extractor tube, where the intake opening is an intake angular extremity of the extractor tube. The plurality of sensors is able to take readings from the representative sample once the representative sample is within the extractor tube. Then the representative sample exits from the extractor tube through the vent opening, where the vent opening is a vent angular extremity of the extractor tube.

The current application claims a priority to the U.S. Provisional Patent application Ser. No. 61/549,971 filed on Oct. 21, 2011.

### FIELD OF THE INVENTION

The present invention relates generally to an apparatus and a method for exhaust gas monitoring. More specifically, the present invention is an apparatus and a method for exhaust gas measuring systems for boilers, turbines, and engine-based electricity generators.

### BACKGROUND OF THE INVENTION

Exhaust gas monitoring has become particularly important due to stringent regulatory emissions limits on boilers, turbines and engine based electricity generators. The electronic portion of the sensors that measure exhaust gas emissions are typically rated for operation in temperatures which are lower than the exhaust gas temperatures. When the exhaust ducts are large it is useful to extract a representative continuous sample of the exhaust gas so that sensors can be placed in the smaller extractor as opposed to the large exhaust duct coming from the boiler, turbine or engine based generator. It is therefore an object of the present invention to provide an apparatus and a method for an external extractor which allows a representative sample of the exhaust duct flow to be diverted so that it can be read by sensors installed in the extractor while protecting the sensors from the high temperatures.

### BRIEF DESCRIPTION OF THE DRAWINGS

FIG. 1 is a perspective view of the present invention.

FIG. 2 is a side view of the present invention.

FIG. 3 is a side view of the present invention where the present invention illustrates a sensor section and an exhaust duct.

FIG. 4 is a front view of the present invention where the present invention illustrates an intake section and the exhaust duct.

FIG. 5 is a front view of the present invention and the exhaust duct.

FIG. 6 is a cross section view of the FIG. 5.

FIG. 7 is the cross section view of the FIG. 5 showing high pressure region and low pressure region.

FIG. 8 is a simplified flow chart illustrating the overall method of the present invention.

FIG. 9 is a simplified flow chart illustrating connection of the present invention to the exhaust duct.

### DETAIL DESCRIPTIONS OF THE INVENTION

All illustrations of the drawings are for the purpose of describing selected versions of the present invention and are not intended to limit the scope of the present invention.

The present invention is an apparatus of a gas extractor which attaches with an exhaust duct 10 in order to monitor an emitting gas flow 6. The boiler exhaust system, the turbine exhaust system, the engine exhaust system, or any other mechanical devices with exhaust systems can be considered as the exhaust duct 10. A representative sample 7 of the emitting gas flow 6 is redirected through the present invention so that the representative sample 7 can be monitored for required properties. The present invention comprises an extractor tube 2, an intake opening 3, a vent opening 4, and a plurality of sensors 5.

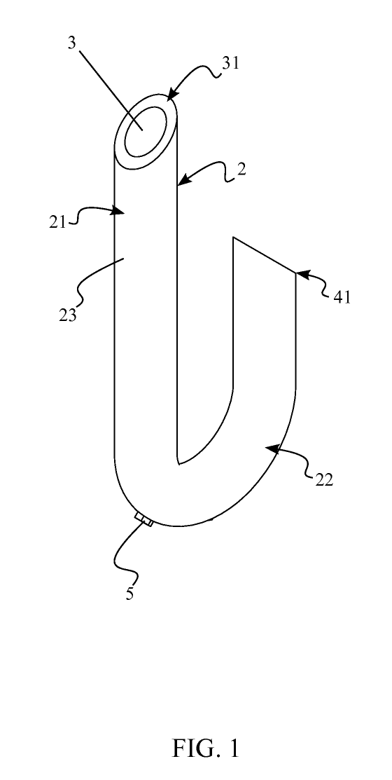

In reference to FIG. 1 and FIG. 6, the extractor tube 2 comprises an intake section 21, a sensor section 22, an outer wall 23, and an inner wall 24. In the preferred embodiment of the present invention, the sensor section 22 comprises a U-shaped, but the sensor section 22 is not limited to the U-shaped and can be modified into any other smooth air flowing shapes. The intake section 21 is adjacently positioned on top of the sensor section 22 from one end, where the intake section 21 is vertically protruded above the sensor section 22. The intake section 21 and the sensor section 22 of the present invention are seamlessly connected to each other where the extractor tube 2 is a single continuous section. The outer wall 23 and the inner wall 24 are extended from one end to the other end of the extractor tube 2. In the preferred embodiment of the present invention, the outer wall 23 comprises a cylindrical shape, but the outer wall 23 can be shaped into triangular shape, rectangular shape, aerodynamic shape, or any other geometric shapes in order to compensate different systems. The inner wall 24 is completed with a frictionless cylindrical shape so that the drag of the representative sample 7 can be minimized.

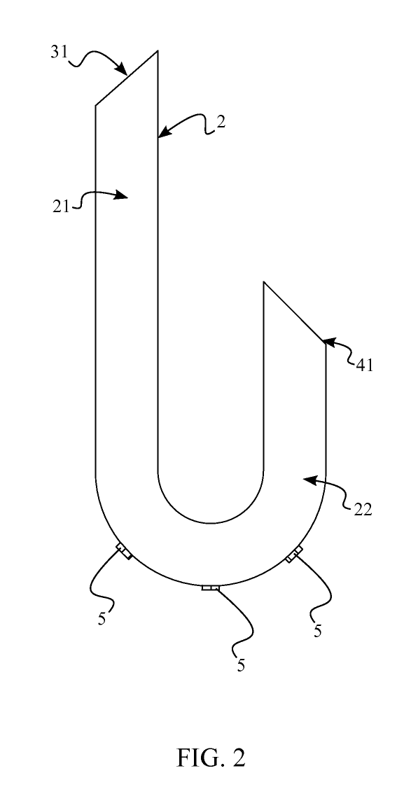

In reference to FIG. 1, FIG. 2, and FIG. 6, the intake opening 3 is adjacently positioned with the intake section 21, where the intake opening 3 is an intake angular extremity 31. The intake angular extremity 31 provides the optimal angle so that the representative sample 7 is entered into the extractor tube 2 without creating turbulent flow within the exhaust duct 10. The vent opening 4 is adjacently positioned with the sensor section 22, where the vent opening 4 is a vent angular extremity 41. The plurality of sensors 5 is traversed though the outer wall 23 and the inner wall 24 of the sensor section 22, where the plurality of sensors 5 is hermetically attached to the sensor section 22. Only the required components of the plurality of sensors 5 are exposed within the inner wall 24 so that other components of the plurality of sensors 5 are protected away from the increased temperature of the representative sample 7. Depending on the system, the plurality of sensors 5 can be interchanged in order to accommodate different measurements. For example, one system can have the plurality of sensors 5 to detect combustible, flammable, and toxic gas, and another system can have the plurality of sensors 5 to detect oxygen depletion. In alternate embodiments, the plurality of sensors 5 can also be permanently connected with the sensor section 22.

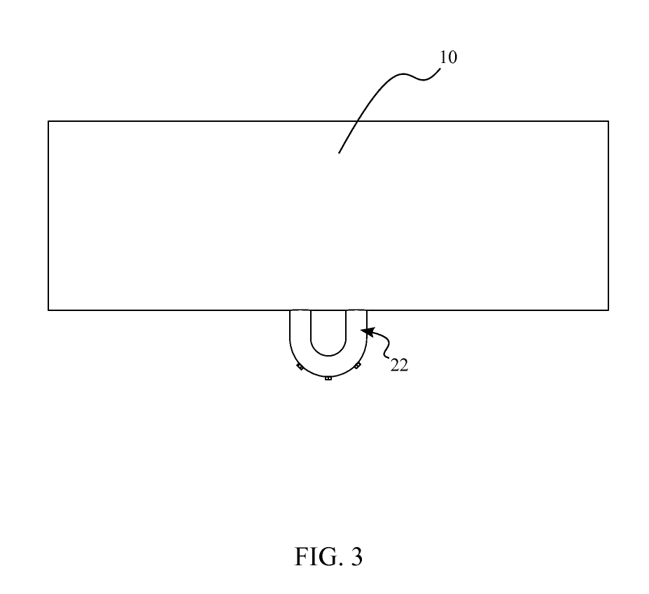

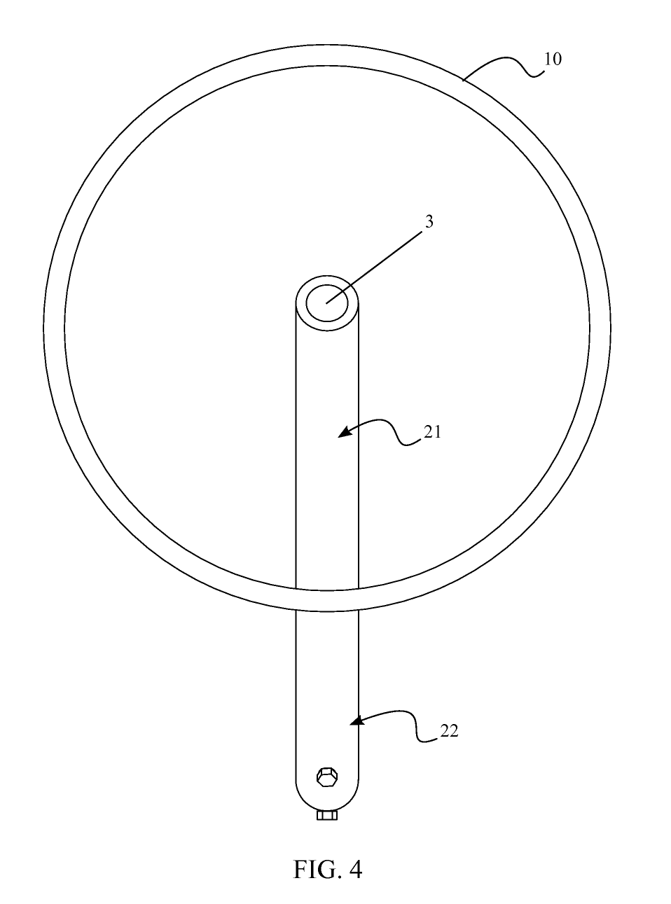

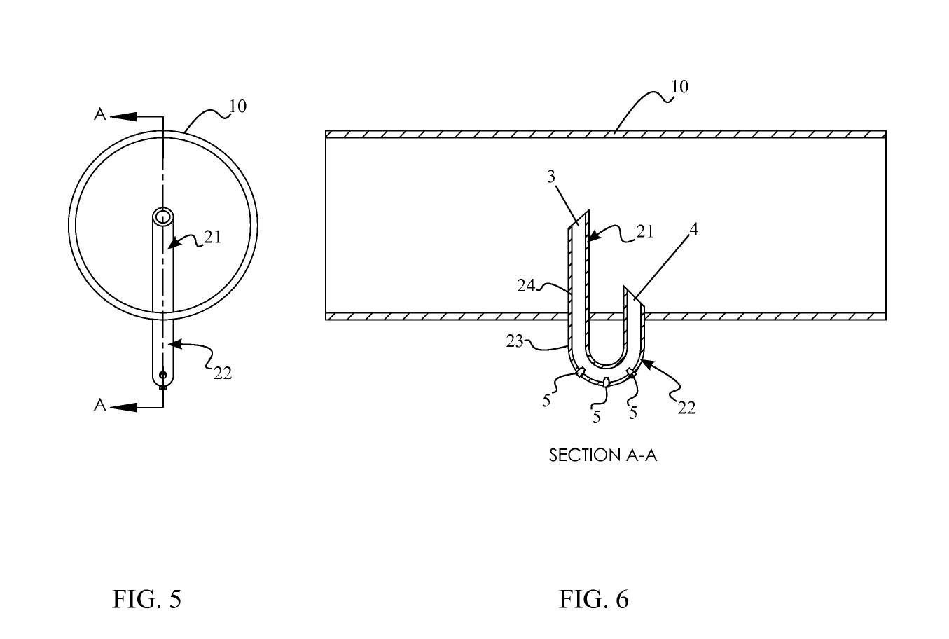

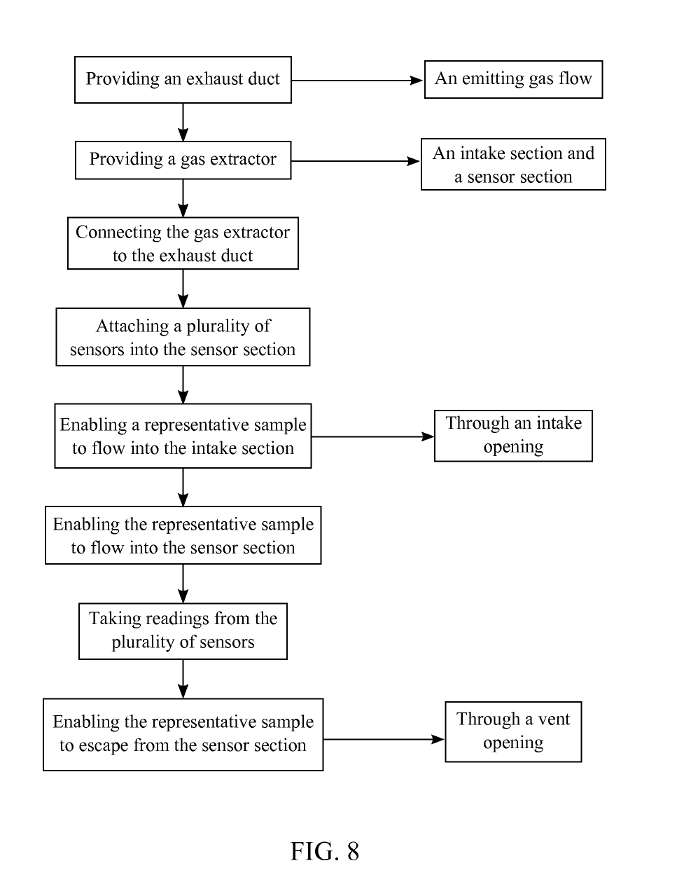

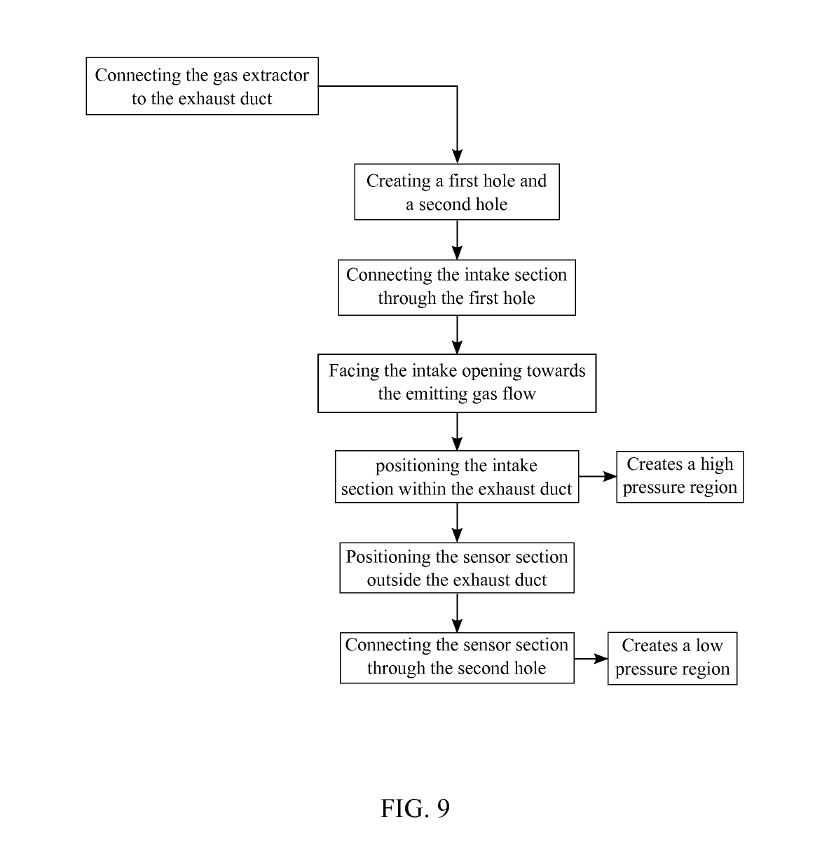

In reference to FIGS. 3-9, the present invention can be installed to the exhaust duct 10 by creating two inline holes, a first hole and a second hole, so that the intake section 21 can be inserted through the first hole, and the vent angular extremity 41 of the vent opening 4 can be inserted within the second hole. The intake section 21 centrally positioned within the exhaust duct 10. The connection between the present invention and the exhaust duct 10 is completely sealed in order to prevent leaking air from the first hole and the second hole or entering air into the first hole and the second hole. The intake opening 3 of the intake section 21 faces toward the emitting gas flow 6 and centrally positioned within the exhaust duct 10. When the emitting gas flow 6 hits the intake section 21, the emitting gas flow 6 travels around the intake section 21 where the emitting gas flow 6 creates a high pressure region 8. Simultaneously, the representative sample 7 flows into the intake section 21 through the intake opening 3.

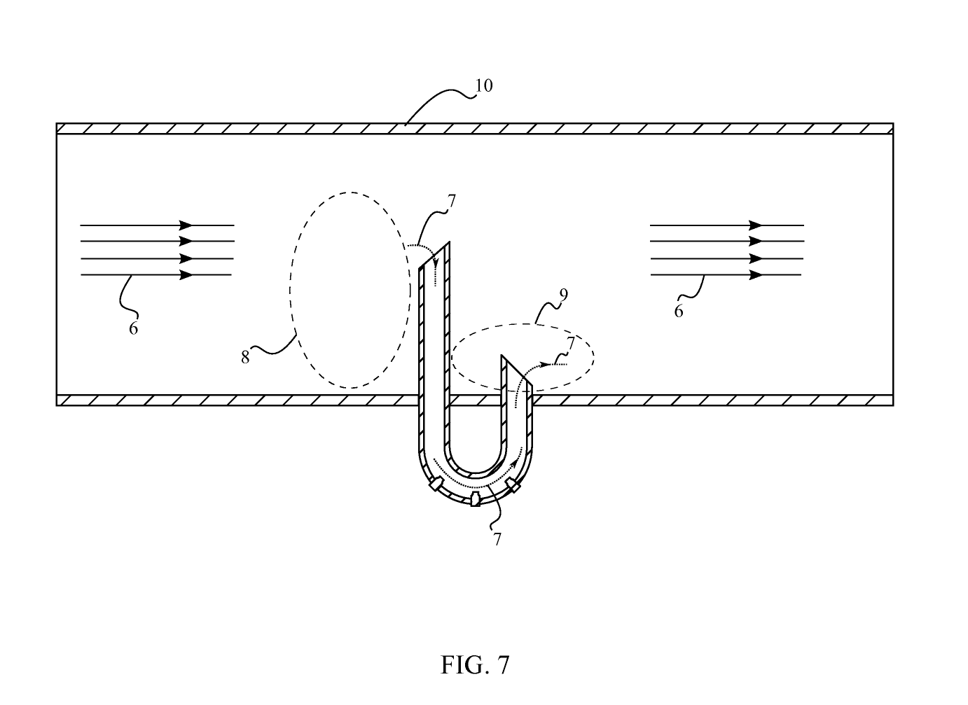

In reference to FIG. 7, the emitting gas flow 6 continuously travels through the exhaust duct 10 and around the intake section 21 while the representative sample 7 travels though the extractor tube 2. The emitting gas flow 6 that travels around the intake section 21 flows with parallel layers, with no disruption between the layers, and the emitting gas flow 6 includes no cross currents perpendicular to the emitting gas flow 6, nor eddies or swirls of fluids. All of the above properties conclude that the emitting gas flow 6 is laminar flow. The emitting gas flow 6 that flows around the intake section 21 creates a void space behind the intake section 21 which is known as a low pressure region 9. Depending of the shape of the outer wall 23 of the intake section 21, the low pressure region 9 can be expanded or abbreviated. For example, when the outer wall 23 comprises a cylindrical shape, the low pressure region 9 is bigger in contrast to an aerodynamic shaped outer wall 23 where the low pressure region is smaller. The representative sample 7 is able to flow through the extractor tube 2 uniformly due to the pressure differences in the high pressure region 8 and the low pressure region 9.

The representative sample 7 then flows through the intake section 21 and into the sensor section 22. The representative sample 7 then flows through each of the plurality of sensors 5, and each of the plurality of sensors 5 measures different aspect of the emitting gas flow 6. The plurality of sensors 5 is positioned within the sensor section 22 and exposed to the representative sample 7 so that accurate measurements can be obtained. At the same time, the plurality of sensors 5 does not create turbulent flow within the extractor tube 2. The present invention allows the plurality of sensors 5 to make representative measurements of the emitted gas flow without directly inputting into the exhaust duct 10 which may comprises the functionality of the plurality of sensors 5. After the representative sample 7 travels through the plurality of sensors 5, the representative sample 7 exits into the exhaust duct 10 through the vent opening 4. Then the representative sample 7 joins with the emitting gas flow 6 and flows out from the exhaust duct 10.

The present invention can be installed into the exhaust duct 10 with different diameters, but the exhaust duct with larger diameter benefits the most from the present invention. For example, if the exhaust duct 10 comprises a large diameter and does not have the present invention, the increased temperature of the emitting gas flow 6 can damage the plurality of sensors 5, which are centrally installed, since the plurality of sensors 5 is fully exposed to the increased temperature of the emitting gas flow 6. The users of the present invention can completely eliminate the above problem by installing the present invention to the exhaust duct 10 that comprises a large diameter. Although the invention has been explained in relation to its preferred embodiment, it is to be understood that many other possible modifications and variations can be made without departing from the spirit and scope of the invention as hereinafter claimed.

What is claimed is:

1. An apparatus of a gas extractor for exhaust gas monitoring comprises,
an extractor tube;
an intake opening;
a vent opening;
a plurality of sensors;
the extractor tube comprises an intake section, a sensor section, an outer wall, and an inner wall;
the intake opening and the vent opening being adjacently positioned at each of extremities of the extractor tube; and
the plurality of sensors being adjacently positioned with the extractor tube.

2. The apparatus of a gas extractor for exhaust gas monitoring as claimed in claim 1 comprises,
the intake section being adjacently positioned atop the sensor section;
the intake opening and the vent opening being oppositely positioned from each other;
the intake opening being adjacently positioned with the intake section, wherein the intake opening comprises an intake angular extremity; and
the vent opening being adjacently positioned with the sensor section, wherein the vent opening comprises a vent angular extremity.

3. The apparatus of a gas extractor for exhaust gas monitoring as claimed in claim 1 comprises,
the inner wall being positioned within the outer wall;
the outer wall being continuously extended from the intake angular extremity to the vent angular extremity; and
the inner wall being continuously extended from the intake angular extremity to the vent angular extremity.

4. The apparatus of a gas extractor for exhaust gas monitoring as claimed in claim 1 comprises, the plurality of sensors being individually traversed through the outer wall and the inner wall; and
the plurality of sensors being hermetically attached to the sensor section.

5. An apparatus of a gas extractor for exhaust gas monitoring comprises,
an extractor tube;
an intake opening;
a vent opening;
a plurality of sensors;
the extractor tube comprises an intake section, a sensor section, an outer wall, and an inner wall;
the intake opening and the vent opening being adjacently positioned at each of extremities of the extractor tube;
the plurality of sensors being adjacently positioned with the extractor tube;
the plurality of sensors being individually traversed through the outer wall and the inner wall; and
the plurality of sensors being hermetically attached to the sensor section.

6. The apparatus of a gas extractor for exhaust gas monitoring as claimed in claim 5 comprises,
the intake section being adjacently positioned atop the sensor section;
the intake opening and the vent opening being oppositely positioned from each other;
the intake opening being adjacently positioned with the intake section, wherein the intake opening comprises an intake angular extremity; and
the vent opening being adjacently positioned with the sensor section, wherein the vent opening comprises a vent angular extremity.

7. The apparatus of a gas extractor for exhaust gas monitoring as claimed in claim 5 comprises,
the inner wall being positioned within the outer wall;
the outer wall being continuously extended from the intake angular extremity to the vent angular extremity; and
the inner wall being continuously extended from the intake angular extremity to the vent angular extremity.

8. A method of monitoring emissions limits on the exhaust duct using a gas extractor comprises the steps of:
providing an exhaust duct, wherein the exhaust duct comprises an emitting gas flow;
providing a gas extractor, wherein the gas extractor comprises an intake section and a sensor section;
connecting the gas extractor to the exhaust duct;
hermetically attaching a plurality of sensors into the sensor section, wherein the plurality of sensors can be interchanged;
enabling a representative sample of the emitting gas flow to flow into the intake section through an intake opening, wherein the representative sample is attained from the emitting gas flow;
enabling the representative sample to flow into the sensor section;
individually taking readings from the plurality of sensors in the sensor section; and
enabling the representative sample to escape from the sensor section through a vent opening.

9. The method of monitoring emissions limits on the exhaust duct using a gas extractor as claimed in claim 8 comprises,
creating two inline holes, wherein the two inline holes comprises a first hole and a second hole;
connecting the intake section inside the exhaust duct through the first hole;
facing the intake opening towards the emitting gas flow;
centrally positioning the intake section within the exhaust duct, wherein a high pressure region is created;
positioning the sensor section outside the exhaust duct;
positioning the vent opening flush in the exhaust duct behind the intake section, wherein a low pressure region is created; and
connecting the sensor section to the exhaust duct through the second hole.

10. The method of monitoring emissions limits on the exhaust duct using a gas extractor as claimed in claim 8 comprises,
wherein an inner wall of the gas extractor comprises a frictionless cylindrical shape.
